(19) United States
(12) Patent Application Publication
(10) Pub. No.: US 2025/0325434 A1
(43) Pub. Date: Oct. 23, 2025

(54) SHOULDER TRAINING DEVICE

(71) Applicant: P & S MECHANICS CO., LTD., Seoul (KR)

(72) Inventors: Kwang Hun PARK, Seoul (KR); Jong Hyeok KIM, Siheung-si, Gyeonggi-Do (KR); Kyung Hwan LEE, Anyang-si, Gyeonggi-do (KR)

(21) Appl. No.: 18/870,376

(22) PCT Filed: Sep. 14, 2022
(86) PCT No.: PCT/KR2022/013716

§ 371 Date: Nov. 27, 2024

(30) Foreign Application Priority Data
May 31, 2022 (KR) 10-2022-0066460

(51) Int. Cl. A61H 1/02

(52) U.S. Cl. CPC A61H 1/0281; A61H 2201/0149; A61H 2201/1215; A61H 2201/1463; A61H 2201/1614; A61H 2201/1673; A61H 2203/0431

(57) ABSTRACT

The present inventive concept relates to an exercise device for shoulder rehabilitation, and more particularly, to an exercise device for shoulder rehabilitation, which provides rotational motion corresponding to movement of a shoulder joint.

An exercise device for shoulder rehabilitation according to an embodiment of the present inventive concept may include: a support frame part configured to define a recess area; a first rail part having one end and the other end, which are coupled to the support frame part, and having an arc shape; a second rail part provided to intersect the first rail part, having one end and the other end, which are coupled to the support frame part, and having an arc shape; a transfer connection part provided at a position at which the first rail part and the second rail part intersect each other and movable along at least one of the first rail part or the second rail part; and an arm fixing part connected to the transfer connection part and fixed to a portion of an arm of a trainee.

### TECHNICAL FIELD

The present inventive concept relates to an exercise device for shoulder rehabilitation, and more particularly, to an exercise device for shoulder rehabilitation, which provides rotational motion corresponding to movement of a shoulder joint.

### BACKGROUND ART

In general, an exercise device for shoulder rehabilitation is a device that helps rehabilitation exercises for trainees who have shoulder paralysis symptoms or abnormalities in shoulder joint or shoulder muscle strength and endurance.

Most trainees with shoulder discomfort have difficulty moving their arms on their own, and thus, the trainees performed shoulder exercises by wearing an exercise device for rehabilitation and moving their arms following shoulder movement patterns induced by the exercise device for the shoulder rehabilitation. These exercise devices for the shoulder rehabilitations have motion trajectories due to their unique structure. However, conventional exercise devices for shoulder rehabilitation have the problem of difficulty in securing sufficient motion trajectories for exercises that match the movement of a shoulder joint by being attached to the outside of an arm joint.

To solve the problem, there have been various attempts to further include additional joints in the conventional exercise device for the shoulder rehabilitation, but the addition of the joints may cause new problems, such as making a complex structure of the exercise device for the shoulder rehabilitation or making it difficult to wear.

(Patent Document 1) Korean Patent Publication No. 10-2001-0111030

### DISCLOSURE OF THE INVENTIVE CONCEPT

### Technical Problem

The present inventive concept provides an exercise device for shoulder rehabilitation, which has a compact and lightweight structure capable of securing various motion trajectories that match movement of a shoulder.

### Technical Solution

An exercise device for shoulder rehabilitation according to an embodiment of the present inventive concept may include: a support frame part configured to define a recess area; a first rail part having one end and the other end, which are coupled to the support frame part, and having an arc shape; a second rail part provided to intersect the first rail part, having one end and the other end, which are coupled to the support frame part, and having an arc shape; a transfer connection part provided at a position at which the first rail part and the second rail part intersect each other and movable along at least one of the first rail part or the second rail part; and an arm fixing part connected to the transfer connection part and fixed to a portion of an arm of a trainee.

The first rail part and the second rail part may be rotatably coupled to the support frame part.

The first rail part may have a semicircular shape having a first radius, and the second rail part may have a semicircular shape having a second radius greater than the first radius.

The support frame part may have a “C” shape.

The transfer connection part may include: a first moving unit part coupled to be movable along the first rail part; a second moving unit part coupled to be movable along the second rail part; and a rotation connection part configured to rotatably connect the first moving unit part and the second moving unit part to each other.

The first moving unit part may include: a first side roller part provided to be in contact with both surfaces of the first rail part and slid along the first rail part; and a first inner roller part provided to be in contact with an inner surface of the first rail part and slid along the first rail part.

The second moving unit part may include a second side roller part provided to be in contact with both surface of the second rail part and slid along the second rail part.

The exercise device may further include: a first driving part configured to provide driving force for allowing the transfer connection part to move along the first rail part; and a second driving part configured to provide driving force for allowing the transfer connection part to move along the second rail part, wherein the first driving part and the second driving part may be connected to the support frame part.

The first rail part may include: a first input pulley provided at one end to receive the driving force of the first driving part; a first switching pulley provided at the other end to change a direction of the driving force; and a first wire connected to the transfer connection part via the first input pulley and the first switching pulley, and the second rail part may include: a second input pulley provided at one end to receive the driving force of the second driving part; a second switching pulley provided at the other end to change a direction of the driving force; and a second wire connected to the transfer connection part via the second input pulley and the second switching pulley.

The first driving part may include: a first motor part configured to generate rotational force; and a first reduction set part configured to change at least one of a direction of transmission of the rotational force, a rotational speed, or rotational force, and the second driving part may include: a second motor part configured to generate rotational force; and a second reduction set part configured to change at least one of a direction of transmission of the rotational force, a rotational speed, or rotational force.

The arm fixing part may be rotatably connected to the transfer connection part in a state of being adjustable in interval with the transfer connection part.

The exercise device may further include a position adjustment part connected to the support frame part and capable of adjusting at least one of a vertical position, a horizontal position, or an angle of the support frame part.

The exercise device may further include a chair part on which the trainee is seated, wherein the position adjustment part may be attached to and detached from different positions of the chair part.

The exercise device may further include a controller configured to control at least one of a moving speed, a moving acceleration, a moving position, a moving direction, a moving range, and a moving angle of the transport connection part, or an exercise pattern of the trainee.

### Advantageous Effects

According to the exercise device for shoulder rehabilitation according to the embodiment of the present inventive concept, the shoulder movement of the trainee may be assisted by the transfer connection part that is movable along at least one of the first rail part and the second rail part, each of which has the arc shape, to provide the various and natural spherical motion trajectories that conform to the movement of the shoulder joint having the ball and socket joint, and thus, the trainee may safely perform the shoulder exercise without feeling any discomfort.

In addition, the shoulder exercise that follows the shoulder movement of the trainee along any path on the three-dimensional spherical surface may be performed, and since the center of motion in space is disposed at the shoulder joint of the trainee, the exercise that follows a more free spherical motion trajectory centered on the shoulder joint of the trainee may be performed. Thus, the discomfort that the trainee experiences due to the discrepancy between the center of movement that follows the shoulder joint and the exercise path while the trainee moves along the spherical trajectory for exercise may be improved, and the range of the shoulder exercise of the trainee, which is trained without discomfort, may be expanded.

In addition, since it does not have the arm structure that includes the plurality of joints like the conventional exercise device for shoulder rehabilitation, the structural complexity of the exercise device for the shoulder rehabilitation may be reduced. As the complexity of the structure is improved, the manufacturing productivity of the upper extremitas exercise device may be improved while reducing the manufacturing costs.

### BRIEF DESCRIPTION OF THE DRAWINGS

FIG. 1 is a schematic perspective view of an exercise device for shoulder rehabilitation according to an embodiment of the present inventive concept.

FIG. 2 is a view of the exercise device for the shoulder rehabilitation according to an embodiment of the present inventive concept.

FIG. 3 is a view illustrating movement of a transfer connection part of the exercise device for the shoulder rehabilitation according to an embodiment of the present inventive concept.

FIG. 4 is a perspective view illustrating the transfer connection part of the exercise device for the shoulder rehabilitation according to an embodiment of the present inventive concept.

FIG. 5 is a view illustrating an exercise mode using the exercise device for the shoulder rehabilitation according to an embodiment of the present inventive concept.

### MODE FOR CARRYING OUT THE INVENTIVE CONCEPT

Hereinafter, specific embodiments will be described in more detail with reference to the accompanying drawings. The present inventive concept may, however, be embodied in different forms and should not be construed as limited to the embodiments set forth herein. Rather, these embodiments are provided so that this disclosure will be thorough and complete, and will fully convey the scope of the present inventive concept to those skilled in the art. In the descriptions, the same elements are denoted with the same reference numerals. In the figures, the dimensions of layers and regions are exaggerated for clarity of illustration. Like reference numerals refer to like elements throughout.

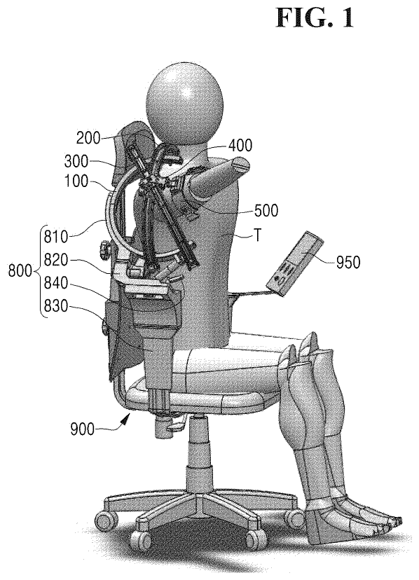

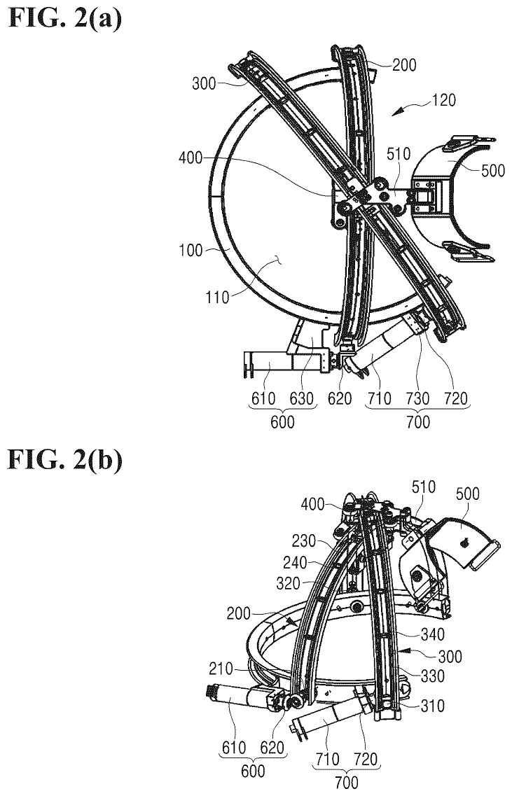

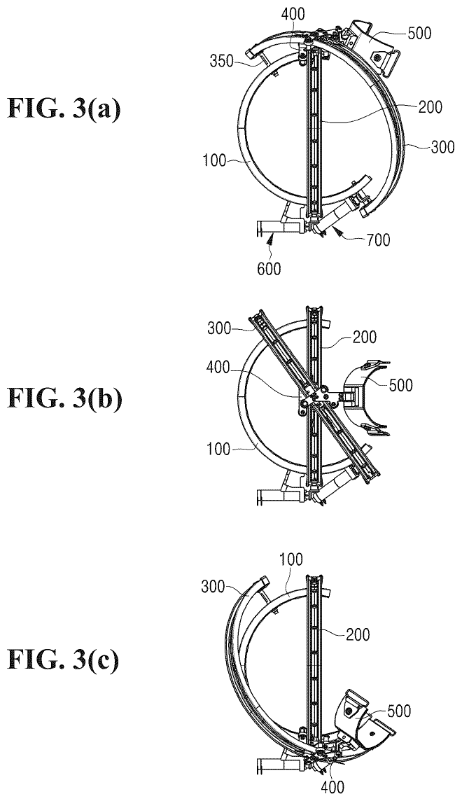

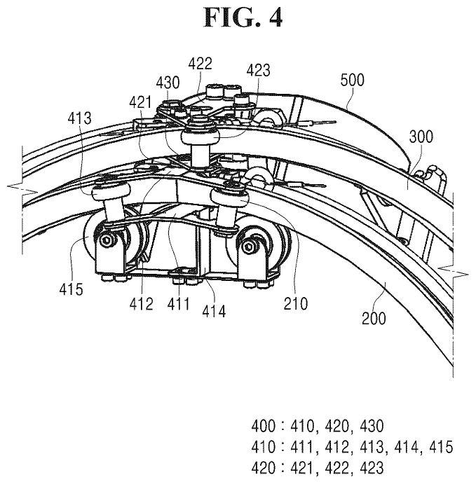

FIG. 1 is a schematic perspective view of an exercise device for shoulder rehabilitation according to an embodiment of the present inventive concept, FIG. 2 is a view of the exercise device for the shoulder rehabilitation according to an embodiment of the present inventive concept (FIG. 2(a) is a front view, and FIG. 2(b) is a perspective view), FIG. 3 is a view illustrating movement of a transfer connection part of the exercise device for the shoulder rehabilitation according to an embodiment of the present inventive concept, and FIG. 4 is a perspective view illustrating the transfer connection part of the exercise device for the shoulder rehabilitation according to an embodiment of the present inventive concept.

Referring to FIGS. 1 to 4, an exercise device for shoulder rehabilitation according to an embodiment of the present inventive concept may include: a support frame part 100 defining a recess area 110; a first rail part 200 having one end and the other end, which are coupled to the support frame part 100, and having an arc shape; a second rail part 300 provided to intersect the first rail part 200, having one end and the other end, which are coupled to the support frame part 100, and having an arc shape; a transfer connection part 400 provided at a position at which the first rail part 200 and the second rail part 300 intersect each other and movable along at least one of the first rail part 200 or the second rail part 300; and an arm fixing part 500 connected to the transfer connection part 400 and fixed to a portion of an arm of a trainee T.

The support frame part 100 serves as a main frame part that is capable of supporting the first rail part 200 and the second rail part 300, which provide various motion trajectories for shoulder movement. The support frame part 100 may define a recess area 110 in which a portion of upper extremitas of the trainee T is accommodated permanently or temporarily during shoulder exercise or during a process of fixing the portion of the upper extremitas of the trainee T. The support frame part 100 may be provided to surround the recess area 110 and include an open part 120 to allow a portion (e.g., shoulder, etc.) of the upper extremitas of the trainee T to freely enter and exit.

The first rail part 200 may have one end and the other end, which are coupled to the support frame part 100 to cross the recess area 110 and may have an arc shape. The second rail part 300 may have one end and the other end, which are coupled to the support frame part 100 to cross the recess area 110 in a direction different from that of the first rail part so as to intersect the first rail part 200 and may have an arc shape. The first rail part 200 and the second rail part 300 may provide a motion trajectory along which the shoulder of the trainee T performs rotational motion along the arc-shaped rail.

The transfer connection part 400 may be provided at a position at which the first rail part 200 and the second rail part 300 intersect each other and may selectively move along at least one of the first rail part 200 or the second rail part 300.

The arm fixing part 500 may be connected to the movable transfer connection part 400 and be fixed to a portion of an arm of the trainee T. When driving force is provided to the transfer connection part 400 to move the transfer connection part 400, an arm fixing part 500 connected to the transfer connection part 400 may be interlocked to enable movement of the arm and shoulder of the trainee T. The arm fixing part 500 may include a covering member (e.g., a cuff, pad, etc.) that wraps around a portion of the arm of the shoulder trainee T.

The first rail part 200 and the second rail part 300 may be rotatably coupled to the support frame part 100. That is, the first rail part 200 may rotate at a predetermined angle by using a virtual straight line connecting one end to the other end of the first rail part 200, which are coupled to the support frame part 100, as a rotation center axis, and the second rail part 300 may rotate at a predetermined angle by using a virtual straight line connecting one end to the other end of the second rail part 300, which are coupled to the support frame part 100, as a rotation center axis. A joint part including a rotation shaft 350 and a bearing provided around the rotation shaft 350 so as to be rotatable may be provided to one end and the other end of the first rail part 200 or the second rail part 300, which are coupled to the support frame part 100.

When the transfer connection part 400 provided at the position at which the first rail part 200 and the second rail part 300 intersect each other is movable along at least one of the first rail part 200 or the second rail part 300, the remaining one may be inked to the moving transfer connection part 400 to rotate along the rotation center axis so that the transfer connection part 400 performs a stable spherical motion. As a result, the shoulder movement of the trainee T may be assisted by the transfer connection part 400 that is movable along at least one of the first rail part 200 and the second rail part 300, each of which has the arc shape, to provide the various and natural spherical motion trajectories that conform to the movement of the shoulder joint having the ball and socket joint, and thus, the trainee T may safely perform the shoulder exercise without feeling any discomfort.

Since the first rail part 200 and the second rail part 300 are interlocked with each other according to the movement of the transfer connection part 400, an angle at which the transfer connection part 400 moves along the first rail part 200 or the second rail part 300 may be determined according to an angle at which the first rail part 200 and the second rail part 300 intersect each other. Thus, a joint part at which one end and the other end of the first rail part 200 or the second rail part 300 are coupled to the support frame part 100 may be provided to be movable along an extension direction of the support frame part 100 so that the angle at which the first rail part 200 and the second rail part 300 intersect each other is changed. The first rail part 200 and the second rail part 300 may further include a fixing member for fixing the joint part so that the joint part is fixed at a predetermined position of the support frame part 100.

The first rail part 200 may have a semicircular shape having a first radius, and the second rail part 300 may have a semicircular shape having a second radius greater than the first radius. The first rail part 200 and the second rail part 300 that are interlocked with and connected to each other by the transfer connection part 400 may be rotatably connected to the support frame part 100. In order for the first rail part 200 and the second rail part 300 to rotate without interfering with the support frame part 100, each of the first rail part 200 and the second rail part may have a semicircular shape. In addition, the first rail part 200 and the second rail part 300 may have different radii so as to stably support the transfer connection part 400 without interfering with each other while rotating around the rotation axis. Here, the first rail part 200 having a small radius may be coupled to the inside of the support frame part 100, and the second rail part 300 having a large radius may be coupled to the outside of the support frame part 100. Alternatively, the first rail part 200 having the small radius may be coupled to an outer surface of the support frame part 100 by contacting or being adjacent thereto, and the second rail part 300 having the large radius may be coupled to an outer end of the rotation shaft 350 extending outward from the support frame part 100.

The support frame part 100 may have a “C” shape.

The support frame part 100 may be a “C”-shaped circular or polygonal shape including an open part 120 to allow a portion (e.g., shoulder, etc.) of the upper extremitas of the trainee T to freely enter and exit. In order for the virtual straight line connecting one end to the other end of the first rail part 200 or the second rail part 300 to pass through the center of the recess area 110 defined by the support frame part 100, an angle (e.g., arc angle) defined by both the ends of the support frame part 100 may be greater than 180 degrees. In addition, the angle defined by both the ends of the support frame part 100 may be greater than 180 degrees and less than 270 degrees so that a portion (e.g., shoulder, etc.) of the upper extremitas of the trainee T may move freely. The support frame part 100 has to not only support the first rail part 200 or the second rail part 300, but also support an arm weight and an exercise load of the trainee T during the shoulder exercise, and thus, the support frame part 100 may have a structurally stable “C”-shaped arc shape.

According to the exercise device for the shoulder rehabilitation according to an embodiment of the present inventive concept, the shoulder exercise that follows the shoulder movement of the trainee T along any path on the three-dimensional spherical surface may be performed, and since the center of motion in space is disposed at the shoulder joint of the trainee T, the exercise that follows a more free spherical motion trajectory centered on the shoulder joint of the trainee T may be performed. Thus, the discomfort that the trainee T experiences due to the discrepancy between the center of movement that follows the shoulder joint and the exercise path while the trainee T moves along the spherical trajectory for exercise may be improved, and the range of the shoulder exercise of the trainee, T which is trained without discomfort, may be expanded.

Particularly, when the support frame part 100 is provided in the “C”-shaped arc shape, it may be easy to place the shoulder joint portion of the trainee T at the center point of movement in space (for example, a center area of the recess area 110 through which the virtual straight line connecting one end to the other end of the first rail part 200 or the second rail part 300 passes), and thus the trainee T may easily wear the exercise device for the shoulder rehabilitation and perform exercise that follows the spherical motion trajectory.

The transfer connection part 400 may include: a first moving unit part 410 coupled to be movable along the first rail part 200; a second moving unit part 420 coupled to be movable along the second rail part 300; and a rotation connection part 430 that rotatably connects the first moving unit part 410 and the second moving unit part 420 to each other.

Since the transfer connection part 400 selectively moves along at least one of the first rail part 200 or the second rail part 300, the transfer connection part 400 may be configured to be divided into the first moving unit part 410 that moves along the first rail part 200 and the second moving unit part 420 that moves along the second rail part 300. In addition, the first rail part 200 and the second rail part 300 may be interlocked with each other to move, and as the first rail part 200 and the second rail part 300 are interlocked with each other to move, an intersection position and angle of the first rail part 200 and the second rail part 300 may be changed, and thus, the first moving unit part 410 and the second moving unit part 420 may be rotatably connected to each other by the rotation connection part 430.

As illustrated in FIG. 3, when the transfer connection part 400 moves along the first rail part 200 to an upper portion (see FIG. 3(a)), a central portion (see FIG. 3(b)), and a lower portion (see FIG. 3(c)), the second rail part 300 connected to the transfer connection part 400 may also rotate around the rotation shaft 350, and thus, the intersection position and angle of the first rail part 200 and the second rail part 300 may be changed. Due to the transfer connection part 400 having this structure, a path provided by the first rail member 200 and the second rail member 300 may be combined to move along a three-dimensional spherical trajectory. If the first moving unit part 410 and the second moving unit part 420 are not rotatably connected to each other, the first rail part 200 and the second rail part 300 may be fixed to prevent the transfer connection part 400 from moving.

In order for the trainee T to safely perform the shoulder exercise along the sufficiently spherical motion trajectory without feeling discomfort, the transfer connection part 400 may need to move smoothly and stably along the first rail member 200 and the second rail member 300.

For this, the first moving unit part 410 may include: a first side roller part 413 provided to be in contact with both sides of the first rail part 200 and be slid along the first rail part 200; and a first inner roller part 415 provided to contact an inner side of the first rail part 200 and be slid along the first rail part 200.

The first rail part 200 may include opposing sidewalls defining both surfaces, and a bottom portion defining an inner surface connecting the sidewalls to each other. In order for the first moving unit part 410 to move stably and smoothly along the first rail part 200 having the three-dimensional structure in the arc shape, the first moving unit part 410 may be prevented from being separated in a lateral direction by the first side roller part 413 that rotates and is slid while being in contact with both the surfaces of the first rail part 200. The first side roller part 413 may be provided between a first upper plate 411 and a first lower plate 412, which are provided at upper and lower sides of the first rail part 200, respectively. Each of the first upper plate 411 and the first lower plate 412 may be bent or have an arc shape corresponding to a curvature of the arc shape of the first rail part 200.

Since the transfer connection part 400 provides the three-dimensional spherical trajectory, the first inner roller part 415 may be provided to be in contact with the inner surface of the first rail part 200 and may be slid while rotating along the first rail part 200 to support the first rail part 200 so as not to be separated in a radial or thickness direction. The first moving unit part 410 may further include an inner plate 414 that extends inward from the first lower plate 412 to support the first inner roller part 415. A roller part may be provided on an outer surface of the second rail part 300 to support the first rail part 200 or the second rail part 300 in the radial or thickness direction while the transfer connection part 400 moves. However, when the roller part is provided on the inner surface of the first rail part 200, the inner surface of the first rail part having the arc shape may be pressed outward, and thus, the roller part may be in closer contact with the first rail part 200, and the first rail part 200 may also stably support force directed in an outward direction due to adhesion of the roller part. As a result, it may be more preferable than providing the roller part on an outer surface of the second rail part 300.

The second moving unit part 420 may include a second side roller part provided to be in contact with both surfaces of the second rail part 300 and slid along the second rail part.

The second rail part 300 may include opposing sidewalls defining both surfaces, and a bottom portion defining an inner surface connecting the sidewalls to each other. In order for the second moving unit part 420 to move stably and smoothly along the second rail part 300 having the three-dimensional structure in the arc shape, the second moving unit part 420 may be prevented from being separated in a lateral direction by the second side roller part 423 that rotates and is slid while being in contact with both the surfaces of the second rail part 300. The second side roller part 423 may be provided between a second upper plate 421 and a second lower plate 422, which are provided at upper and lower sides of the second rail part 300, respectively. Each of the second upper plate 421 and the second lower plate 422 may be bent or have an arc shape corresponding to a curvature of the arc shape of the second rail part 300.

The rotation connection part 430 that rotatably connects the first moving unit part 410 to the second moving unit part 420 may be provided between the first upper plate 411 and the second lower plate 422.

The exercise device for the shoulder rehabilitation according to an embodiment of the present inventive concept may further include: a first driving part 600 that provides driving force to allow the transfer connection part 400 to move along the first rail part 200; and a second driving part 700 that provides driving force to allow the transfer connection part 400 to move along the second rail part 300, and the first driving part 600 and the second driving part 700 may be connected to the support frame part 100.

In the case of the shoulder exercise by magnetic force of the trainee T, the transfer connection part 400 may move according to the shoulder movement of the trainee T, but in the case in which the movement of the trainee T by the magnetic force is difficult, the shoulder movement of the trainee T may be possible by driving the transfer connection part 400 at a predetermined angle and speed. Thus, the first driving part 600 may provide driving force to the transfer connection part 400 to move along the first rail part 200, and the second driving part 700 may provide driving force to the transfer connection part 400 to move along the second rail part 300.

The first driving part 600 and the second driving part 700 may be stably supported by being connected to the support frame part 100 that forms a frame supporting the first rail part 200 and the second rail part 300. Since the support frame part 100 serves as the frame, the support frame part 100 may have a thickness and width greater than those of each of the first rail part 200 and the second rail part 300 and may be effective in supporting the first driving part 600 and the second driving part 700.

In the case of mounting the first driving part 600 and the second driving part 700 on the transfer connection part 400 to directly transmit the driving force to the transfer connection part 400, the first rail part 200 and the second rail part 300 supporting the transfer connection part 400 may cause a bending problem due to the weight of the first driving part 600 and the second driving part 700 and the load caused by the driving force provided by the first driving part 600 and the second driving part 700. In order to solve this bending problem, the first rail part 200 and the second rail part 300 have to be thickened or have a complex shape. As a result, it may be difficult to allow the first rail part 200 and the second rail part 300 to rotate, and it may be also difficult to allow the exercise device for the shoulder rehabilitation to be smaller and lighter.

The first driving part 600 may include: a first motor part 610 that generates rotational force; and a first reduction set part 620 that changes at least one of a transmission direction of the rotational force, a rotational speed, or rotational force. The first driving part 600 may further include a first connection support part 630 that connects and couples the first motor part 610 and the first reduction set part 620 to the support frame part 100. The first motor part 610 may generate the rotational force that enables the transfer connection part 400 to move along the first rail part 200, and the generated rotational force may be output by changing at least one of the transmission direction, the rotational speed, or the rotational force by the first reduction set part 620.

The second driving part 700 may include: a second motor part 710 that generates rotational force separately from the first driving part 600 so that the transfer connection part 400 moves independently along the second rail part 300; and a second reduction set part 720 that changes at least one of the transmission direction, the rotational speed, or the rotational force of the rotational force. The second driving part 700 may further include a second connection support part 730 that connects and couples the second motor part 710 and the second reduction set part 720 to the support frame part 100.

The driving force provided by the first driving part 600 may be transmitted to the transfer connection part 400 by the driving force transmission means such as a gear, but in order to reduce a size and weight of the first rail part 200, the driving force may be transmitted to the transfer connection part 400 by using a wire.

The first rail part 200 may include: a first input pulley 210 provided at one end to receive the driving force from the first driving part 600; a first switching pulley 220 provided at the other end to change a direction of the driving force; and a first wire 230 connected to the transfer connection part 400 via the first input pulley 210 and the first switching pulley 220. The driving force output from the first reduction set 620 may be transmitted using the first input pulley 210, and the input driving force may be transmitted to the transfer connection part 400 by the first wire 230 that is connected to the transfer connection part 400 in a closed loop shape via the first switching pulley 220. A transfer direction of the transfer connection part 400 may be determined by the rotation direction of the first motor part 610.

The first rail part 200 may provide an accommodation space by the opposing sidewalls defining both the surfaces and the bottom portion defining the inner surface connecting the sidewalls, and the first input pulley 210, the first switching pulley 220, and the first wire 230 may be provided in the accommodation space. A plurality of first transfer roller parts 240 may be disposed at regular intervals on the bottom portion to ensure smooth transfer of the first wire 230.

The second rail part 300 may include: a second input pulley 310 provided at one end to receive the driving force from the second driving part 700; a second switching pulley 320 provided at the other end to change a direction of the driving force; and a second wire 330 connected to the transfer connection part 400 via the second input pulley 310 and the second switching pulley 320. The second rail part 300 may further include a second transfer roller part 340 to smoothly transfer the second wire 330, and a power transmission mechanism of the second rail part 300 may be the same as a power transmission mechanism of the first rail part 200 described above and thus will be omitted.

The arm fixing part 500 may be rotatably connected to the transfer connection part 400 in a state of being adjustable in interval between the arm fixing part 500 and the transfer connection part 400.

The arm of the trainee T may be fixed to the arm fixing part 500, and the arm fixing part 500 may be connected to the transfer connection part 400, and thus, the arm of the trainee T may follow the movement of the transfer connection part 400 to perform the shoulder exercise. In order to perform the shoulder exercise that follows the shoulder movement of the trainee T along any path on the three-dimensional spherical surface, the center of motion for the spherical motion trajectory has to be disposed at the shoulder joint of the trainee T. However, it is necessary to adjust the interval between the arm fixing part 500 and the transfer connection part 400 of the exercise device of the shoulder rehabilitation so that the shoulder joint is disposed near the center of movement (e.g., the center of the recess area 110 which is symmetrical with respect to the first rail part 200 and the second rail part 300, each of which has the arc shape) depending on the arm length of the trainee T. The arm fixing part 500 may be connected to the transfer connection part 400 by the arm fixing part support part 510. One end of the arm fixing part support part 510 may be rotatably connected to the transfer connection part 400, and the other end of the arm fixing part support part 510 may be rotatably connected to the arm fixing part 500. In addition, the interval between the arm fixing part 500 and the transfer connection part 400 may be adjusted by a linear guide member (not shown) provided along an extension direction of the arm fixing member support member 510 and a linearly moving member (not shown) inserted into the linear guide member. The structure of the arm fixing part support part 510 may not be particularly limited thereto, and any structure that is capable of adjusting the interval between the arm fixing part 500 and the transfer connection part 400 may be sufficient and be transformed into various forms.

The exercise device for the shoulder rehabilitation according to an embodiment of the present inventive concept may further include a position adjustment part 800 that is connected to the support frame part 100 to adjust at least one of a vertical position, a horizontal position, or an angle of the support frame part 100.

It is necessary to change the position and angle of the support frame part 100 corresponding to the shoulder joint portion depending on the position and direction of the shoulder and arm of the trainee T. For this, the position adjustment part 800 may include: a height adjustment part 830 for adjusting a height of the support frame part 100; a horizontal position adjustment part 820 connected to the height adjustment part so as to be linearly movable by being guided by the linear guide unit provided on one surface of the height adjustment part 830; and an angle adjustment part 810 rotatably connected to an end of the horizontal position adjustment part 820.

The position adjustment part 800 may be independently connected to the support frame part 100 or may be provided to be attached to a mechanism such as a chair part on which the trainee T is seated. In addition, the position adjustment part 800 may move to a right shoulder position and a left shoulder position of the trainee T in response to the right shoulder exercise and the left shoulder exercise of the trainee T. The exercise device for the shoulder rehabilitation according to an embodiment of the present inventive concept may further include a chair part 900 on which the trainee T is seated, and the position adjustment part 800 may be provided to be attachable and detachable to different positions of the chair part 900.

The chair part 900 may enable the trainee T to exercise the shoulder joint while being seated on a chair. The chair part 900 may include a chair moving part that provides rotation and movement functions of the chair and includes caster wheels, a chair height adjusting part that is capable of adjusting a seated height of the trainee T, and an upper body support part that is capable of supporting an upper body of the trainee T and includes a backrest and a neckrest, which are adjusted by the guide member. The chair height adjustment part may include a height adjustment compensation part and a height adjustment lever. The upper body support part may include a backrest that is guided by an upper body height adjustment guide member and is adjustable by the backrest lever, and a neckrest that is guided by a neck height adjustment guide member and is adjustable by the neckrest lever.

When the position adjustment part 800 is provided to be coupled to the chair part 900, it can be provided to be attached and detached to different positions of the chair part 900 in response to the right shoulder exercise and left shoulder exercise of the trainee T. The position adjustment part 800 may be attached to and detached from the chair part 900 by changing the position of the shoulder to be exercised with a controller 950 described later.

The exercise device for the shoulder rehabilitation according to an embodiment of the present inventive concept may further include the controller 950 that controls at least one of a moving speed, a moving acceleration, a moving position, a moving direction, a moving range, and a moving angle of the transfer connection part 400, or an exercise pattern of the trainee T.

The controller 900 may control the movement and position of the transfer connection part 400 in various manners by operating the first driving part 600 and the second driving part 700 according to movement execution information.

Here, the exercise execution information may include at least one of the movement speed, the movement acceleration, the movement position, the movement direction, the movement range, and the movement angle of the transfer connection part 400, or the exercise pattern of the trainee T. For example, the controller 950 may adjust an actual movement speed of the transfer connection part 400 by operating the driving part so that the transfer connection part 400 moves according to the movement speed of the transfer connection part 400, which is contained in the exercise execution information.

In addition, the exercise device for the shoulder rehabilitation according to an embodiment of the present inventive concept may further include a detection part (not shown). The detection part (not shown) may be electrically connected to the controller 900 to detect at least one of the position, the movement speed, the movement acceleration, or the movement direction of the transfer connection part 400 and then transmit the detected information to the controller 900 so that the controller 900 controls the movement and position of the transfer connection part 400 by operating the first driving part 600 and the second driving part 700. The detection part may include an acceleration sensor or a gyro sensor for detecting the moving speed or position of the transfer connection part 400.

The controller 900 may adjust the operation of the first driving part 600 and the second driving part 700 based on the detection information regarding the position, the movement speed, and the movement direction of the transfer connection part 400, which are received from the detection part.

The controller 950 may also generate a customized control signal according to the shoulder exercise of the trainee T. Here, as an example of the customized control signal, a signal for controlling the rotational speed or rotational torque of the motor part of each of the first driving part 600 and the second driving part 700 may be heard so that an intensity of forcibly moving the shoulder of the trainee T receiving the shoulder exercise or a speed or acceleration of the rotational movement of the shoulder is controlled to an appropriate level according to conditions of the shoulder muscles or shoulder joint of the trainee T receiving the shoulder exercise.

The controller 950 may include an input/output part (not shown) that receives selection of exercise execution information from the trainee T or the like, or outputs exercise execution information so that the trainee T or the like recognizes the exercise execution information. Examples of the input/output part may include a touch screen that is capable of displaying information on a screen and inputting the selection of the trainee T by touch. In order for the trainee T to understand the contents of the exercise execution information, the controller 950 may transmit the exercise execution information to the touch screen to display the exercise execution information.

In addition, in order to enable the customized shoulder exercise for the trainee T, the exercise execution information may also include information on the history of the trainee's T past shoulder exercise, and information on limitations of the shoulder exercise that are not too much for the trainee T. The limitations of the shoulder exercise may include, for example, limitations of the moving speed or moving angular velocity of the transfer connection part 400, limitations of force, etc.

Referring to the exercise execution information, the trainee T may reset or change the exercise execution information. That is, the trainee T may touch the touchscreen to input information to be changed or reset in the exercise execution information displayed on the touchscreen. The controller 950, which receives the changed or reset exercise execution information from the trainee T may control the movement and position of the transfer connection part 400 by operating the first or second driving part according to the changed or reset exercise execution information, and the shoulder exercise of the trainee T may be executed.

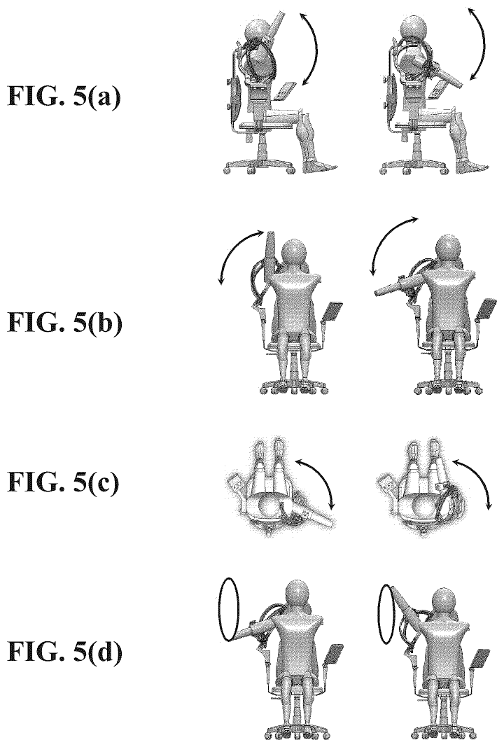

FIG. 5 is a view illustrating an exercise mode using the exercise device for the shoulder rehabilitation according to an embodiment of the present inventive concept. FIG. 5(a) illustrates a shoulder curve and extension exercise, FIG. 5(b) illustrates abduction and adduction exercise, FIG. 5(c) illustrates horizontal abduction and horizontal adduction exercise, and FIG. 5(d) illustrates circular rotation/rotation exercise.

When the controller 950 drives the first driving part 600 and/or the second driving part 700 according to the exercise execution information corresponding to the various exercise modes illustrated in FIG. 5, the exercise may be executed that rotates the shoulder of the trainee T along the arc shape of the first rail part 200 and/or the second rail part as illustrated in FIGS. 5(a) to 5(d).

Particularly, an intersection area of a virtual rotation center axis connecting one end to the other end of the first rail part 200 and a virtual rotation center axis connecting one end to the other end of the second rail part 300 or a predetermined area disposed in a direction perpendicular to the recess area from the intersection area may become a center point of the spherical motion trajectory in space. Since the center point of the spherical motion trajectory in space is disposed at the shoulder joint of the trainee T, the shoulder exercise may be performed by following the three-dimensional spherical trajectory with more freedom in movement centered on the shoulder joint. Therefore, in the process of moving by following the motion trajectory on the three-dimensional trajectory for the shoulder exercise, the discomfort of the trainee T due to the misalignment of the center of the movement following the shoulder joint and the trajectory of the exercise may be improved, and thus, the range of the shoulder exercise that the trainee T receives may be expanded.

In addition, since it is possible to safely provide the sufficient spherical motion trajectory without having the arm structure including the multiple joints like the conventional exercise device for shoulder rehabilitation, the complexity of the structure in the exercise device for the shoulder rehabilitation may be reduced. As the complexity of the structure is improved, the manufacturing productivity of the upper extremitas exercise device may be improved while reducing the manufacturing costs.

The term “˜ on” used in the above description includes direct contact and indirect contact at a position that is opposite to an upper and lower portion. It is also possible to locate not only the entire top surface or the entire bottom surface but also the partial top surface or the bottom surface, and it is used in the mean that it is opposed in position or contact directly to upper or bottom surface. In addition, terms such as ‘top’, ‘bottom’, ‘front end’, ‘rear end’, ‘upper’, ‘lower’, ‘upper end’, ‘lower end’, etc. used in the above description are defined based on the drawings for convenience., the shape and location of each component are not limited by this term.

Although preferred embodiments of the present inventive concept have been described with reference to a number of illustrative embodiments thereof, the embodiments of the limited to the foregoing present inventive concept are not embodiments, and thus, it should be understood that numerous other modifications and embodiments may be devised by those skilled in the art that will fall within the spirit and scope of the principles of this disclosure. Hence, the real protective scope of the present inventive concept shall be determined by the technical scope of the accompanying claims.

1. An exercise device for shoulder rehabilitation, the exercise device comprising:
a support frame part configured to define a recess area;
a first rail part having one end and the other end, which are coupled to the support frame part, and having an arc shape;
a second rail part provided to intersect the first rail part, having one end and the other end, which are coupled to the support frame part, and having an arc shape;
a transfer connection part provided at a position at which the first rail part and the second rail part intersect each other and movable along at least one of the first rail part or the second rail part; and
an arm fixing part connected to the transfer connection part and fixed to a portion of an arm of a trainee.

2. The exercise device of claim 1, wherein the first rail part and the second rail part are rotatably coupled to the support frame part.

3. The exercise device of claim 1, wherein the first rail part has a semicircular shape having a first radius, and
the second rail part has a semicircular shape having a second radius greater than the first radius.

4. The exercise device of claim 1, wherein the support frame part has a “C” shape.

5. The exercise device of claim 1, wherein the transfer connection part comprises:
a first moving unit part coupled to be movable along the first rail part;
a second moving unit part coupled to be movable along the second rail part; and
a rotation connection part configured to rotatably connect the first moving unit part and the second moving unit part to each other.

6. The exercise device of claim 5, wherein the first moving unit part comprises:
a first side roller part provided to be in contact with both surfaces of the first rail part and slid along the first rail part; and
a first inner roller part provided to be in contact with an inner surface of the first rail part and slid along the first rail part.

7. The exercise device of claim 5, wherein the second moving unit part comprises a second side roller part provided to be in contact with both surface of the second rail part and slid along the second rail part.

8. The exercise device of claim 1, further comprising:
a first driving part configured to provide driving force for allowing the transfer connection part to move along the first rail part; and
a second driving part configured to provide driving force for allowing the transfer connection part to move along the second rail part,
wherein the first driving part and the second driving part are connected to the support frame part.

9. The exercise device of claim 8, wherein the first rail part comprises:
a first input pulley provided at one end to receive the driving force of the first driving part;
a first switching pulley provided at the other end to change a direction of the driving force; and
a first wire connected to the transfer connection part via the first input pulley and the first switching pulley, and
the second rail part comprises:
a second input pulley provided at one end to receive the driving force of the second driving part;
a second switching pulley provided at the other end to change a direction of the driving force; and
a second wire connected to the transfer connection part via the second input pulley and the second switching pulley.

10. The exercise device of claim 9, wherein the first driving part comprises:
a first motor part configured to generate rotational force; and
a first reduction set part configured to change at least one of a direction of transmission of the rotational force, a rotational speed, or rotational force, and
the second driving part comprises:
a second motor part configured to generate rotational force; and
a second reduction set part configured to change at least one of a direction of transmission of the rotational force, a rotational speed, or rotational force.

11. The exercise device of claim 1, wherein the arm fixing part is rotatably connected to the transfer connection part in a state of being adjustable in interval with the transfer connection part.

12. The exercise device of claim 1, further comprising a position adjustment part connected to the support frame part and capable of adjusting at least one of a vertical position, a horizontal position, or an angle of the support frame part.

13. The exercise device of claim 12, further comprising a chair part on which the trainee is seated,
wherein the position adjustment part is attached to and detached from different positions of the chair part.

14. The exercise device of claim 1, further comprising a controller configured to control at least one of a moving speed, a moving acceleration, a moving position, a moving direction, a moving range, and a moving angle of the transport connection part, or an exercise pattern of the trainee.
